(19) United States
(12) Patent Application Publication
(10) Pub. No.: US 2015/0138938 A1
(43) Pub. Date: May 21, 2015

(54) MAGNETIC RECORDING MEDIUM, METHOD OF MANUFACTURING THE SAME, AND MAGNETIC RECORDING DEVICE

(71) Applicant: KABUSHIKI KAISHA TOSHIBA, Tokyo (JP)

(72) Inventors: Hironori Teguri, Yamato-shi (JP); Kazutaka Takizawa, Kawasaki-shi (JP)

(73) Assignee: KABUSHIKI KAISHA TOSHIBA, Tokyo (JP)

(21) Appl. No.: 14/198,203

(22) Filed: Mar. 5, 2014

(30) Foreign Application Priority Data
Nov. 19, 2013 (JP) 2013-239319

(51) Int. Cl. G11B 5/65; G11B 5/855; G11B 5/842; G11B 5/73; G11B 5/706

(52) U.S. Cl. CPC G11B 5/65; G11B 5/7325; G11B 5/70605; G11B 5/842; G11B 5/855; G11B 2005/0021
USPC 369/13.33; 428/834; 428/832; 428/831; 427/131; 427/130

(57) ABSTRACT

According to one embodiment, a magnetic recording medium used in a heat assisted magnetic recording system includes a magnetic recording layer and a metal particle layer in which metal particles are arranged in a dispersed manner on a substrate. In the metal particle layer, percentage content of the metal particles in a second region positioned at an outer periphery side of a first region is higher than that of the first region in a surface direction of the substrate.

### CROSS-REFERENCE TO RELATED APPLICATIONS

This application is based upon and claims the benefit of priority from Japanese Patent Application No. 2013-239319, filed on Nov. 19, 2013; the entire contents of which are incorporated herein by reference.

### FIELD

Embodiments described herein relate generally to a magnetic recording medium, a method of manufacturing the same, and a magnetic recording device.

### BACKGROUND

In a heat assisted magnetic recording device using a heat assisted magnetic recording system, a magnetic recording medium is used, which has so large coercivity that only a magnetic field generated by a recording head cannot reverse magnetization. In the heat assisted magnetic recording device, laser light emitted from a laser light source is converted into near-field light in a near-field light generation element incorporated in a magnetic head, and a surface of the magnetic recording medium is locally irradiated with the near-field light. A magnetic recording layer of the magnetic recording medium is locally heated by the near-field light, and is caused to be in a state in which the coercivity is locally decreased. Then, a magnetic field is applied to a region in the magnetic recording layer, where the coercivity is decreased, so that magnetization of the magnetic recording layer is reversed and information is recorded.

In the heat assisted magnetic recording device, most energy of the laser light is converted into heat when the laser light is converted into the near-field light. In the heat assisted magnetic recording device, it is desired to efficiently heat the magnetic recording medium by the near-field light converted from the laser light.

### BRIEF DESCRIPTION OF THE DRAWINGS

FIG. 1 is a perspective view illustrating a partially exploded magnetic recording device according to a first embodiment;

FIG. 2 is a schematic diagram illustrating a configuration of a peripheral part of a magnetic head of the magnetic recording device according to the first embodiment;

FIGS. 3A and 3B are diagrams illustrating a magnetic recording medium according to the first embodiment;

FIGS. 4A to 4C are plan views of a part of a magnetic recording layer and a metal particle layer in the first embodiment as viewed from an upper surface;

FIGS. 5A to 5C are diagrams describing a relative positional relationship between magnetic particles and metal particles in a radial position in the magnetic recording medium according to the first embodiment;

FIG. 6 is a characteristic diagram illustrating a relationship between a required laser current and the radial position in magnetic recording mediums of a comparative example and of an embodiment;

FIG. 7 is a characteristic diagram illustrating a relationship between percentage content of the metal particles in the metal particle layer according to the first embodiment and an increased temperature at heating by near-field light;

FIG. 8 is a flowchart illustrating a procedure of an example of a method of manufacturing a magnetic recording medium according to the first embodiment;

FIGS. 9A to 9I are cross sectional views illustrating processes of forming a metal particle layer in the example of a method of manufacturing a magnetic recording medium according to the first embodiment;

FIGS. 10A to 10F are cross sectional views illustrating processes of a method of manufacturing a metal particle layer according to a second embodiment;

FIGS. 11A to 11J are cross sectional views illustrating processes of a method of manufacturing a metal particle layer according to a third embodiment;

FIG. 12 is a cross sectional view of a part of a magnetic recording medium according to a fourth embodiment;

FIG. 13 is a cross sectional view of a part of a magnetic recording medium according to a fifth embodiment; and

FIG. 14 is a cross sectional view of a part of a magnetic recording medium according to a sixth embodiment.

### DETAILED DESCRIPTION

In general, according to one embodiment, a magnetic recording medium used in a heat assisted magnetic recording system includes a magnetic recording layer and a metal particle layer in which metal particles are arranged in a dispersed manner on a substrate. In the metal particle layer, percentage content of the metal particles in a second region positioned at an outer periphery side of a first region is higher than that of the first region in a surface direction of the substrate.

Exemplary embodiments of a magnetic recording medium, a method of manufacturing the same, and a magnetic recording device will be explained below in detail with reference to the accompanying drawings. The present invention is not limited to the following embodiments.

For easy understanding of the embodiments, scales between members may be different from actual scales. The same applies to the drawings. Further, for easy viewing of the drawings, hatching may be provided even in a plan view.

### First Embodiment

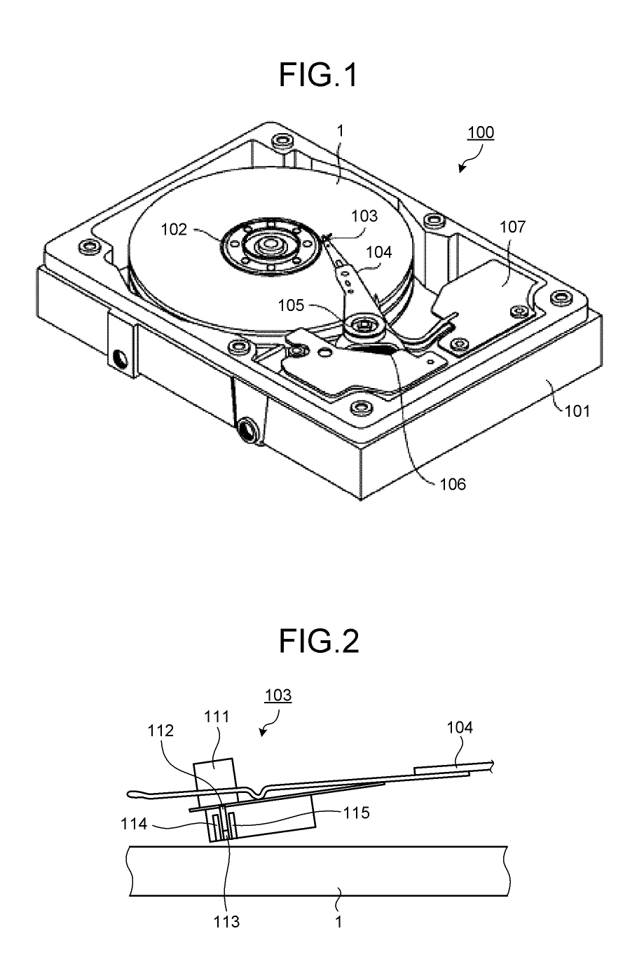

First, an outline of a magnetic recording device 100 according to a first embodiment will be described. FIG. 1 is a perspective view illustrating a partially exploded magnetic recording device 100 according to the first embodiment. The magnetic recording device 100 includes a rectangular box-shaped casing 101 with an upper surface opened, and a top cover (not illustrated) that blocks up the upper end opening of the casing 101 by being screwed to the casing 101 by a plurality of screws.

In the casing 101, a magnetic recording medium for heat assisted magnetic recording 1 according to the present embodiment (hereinafter, may be called magnetic recording medium 1), a spindle motor 102, a magnetic head 103, a head gimbal assembly 104, a rotating shaft 105, a voice coil motor 106, a circuit substrate 107, and the like are accommodated.

The spindle motor 102 supports and rotates the magnetic recording medium 1. The magnetic head 103 applies a magnetic field to the magnetic recording medium 1, heats the magnetic recording medium 1, and records and reads a magnetic signal by a heat assisted system. The head gimbal assembly 104 includes a suspension in which the magnetic head 103 is incorporated in a tip, and supports the magnetic head 103 with respect to the magnetic recording medium 1 in a freely movable manner. The rotating shaft 105 supports the head gimbal assembly 104 in a freely rotatable manner. The voice coil motor 106 rotates and performs positioning of the head gimbal assembly 104 through the rotating shaft 105. The circuit substrate 107 includes wiring connected to the magnetic head 103.

FIG. 2 is a schematic diagram illustrating a configuration of a peripheral part of the magnetic head 103. The magnetic head 103 includes a laser light source 111, a laser light waveguide 112, a near-field light generation element 113, a magnetic field generation element 114, and a reading element 115. The laser light emitted from the laser light source 111 passes through the laser light waveguide 112, and the near-field light generation element 113 is irradiated with the laser light. The near-field light generation element 113 converts the irradiated laser light into near-field light spreading about 50 nm width, for example, and locally irradiates a part of a surface of the magnetic recording medium 1 with the near-field light. A micro region of the magnetic recording layer of the magnetic recording medium 1, on which information is to be recorded, is heated by the near-field light, the coercivity is decreased, and the information can be easily recorded.

The magnetic recording layer in the micro region is then magnetized into a predetermined direction by a magnetic field generated by the magnetic field generation element 114, and the information is recorded. Further, the information recorded in the magnetic recording medium 1 is read out by the reading element 115. That is, the magnetic head 103 functions as a near-field light irradiation unit that irradiates the magnetic recording medium 1 with the near-field light, and also functions as a magnetic field application unit that applies the magnetic field to the magnetic recording medium 1.

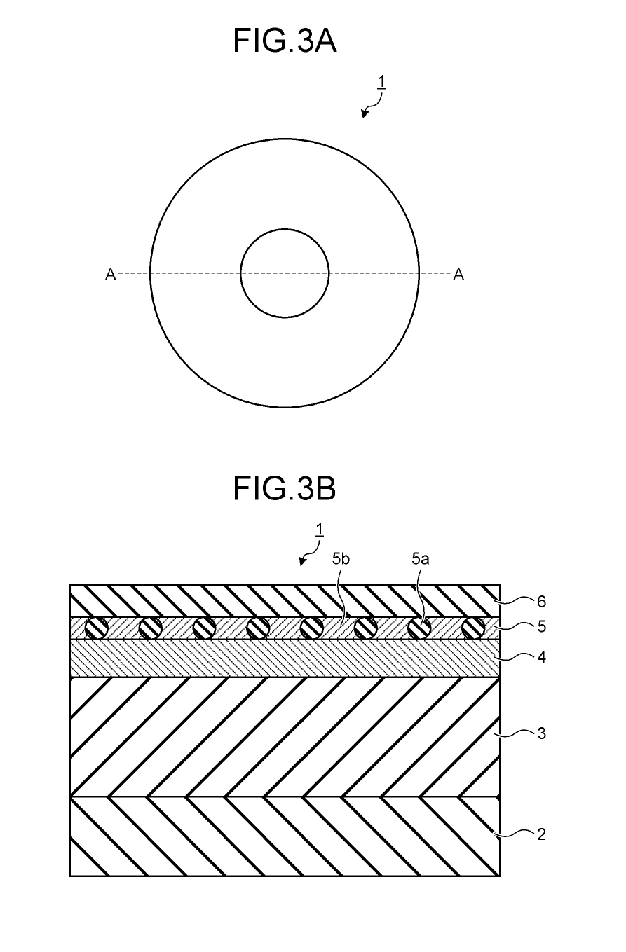

FIGS. 3A and 3B are diagrams illustrating the magnetic recording medium 1 according to the first embodiment, FIG. 3A is a plan view of the magnetic recording medium 1, and FIG. 3B is a cross sectional view of a part in a line segment A-A of FIG. 3A. The magnetic recording medium 1 is a disk-like (doughnut-like) magnetic recording medium that records various types of information. The magnetic recording medium 1 includes a substrate 2, an underlayer 3, a magnetic recording layer 4, a metal particle layer 5, and an overcoat layer 6, formed on one surface of the substrate 2 in that order.

As a material of the substrate 2, a non-magnetic material such as glass, a ceramic, or quarts can be used. As a material of the underlayer 3, which can control crystal orientation of the magnetic recording layer 4, MgO, TiN, or the like can be used. As a material of the magnetic recording layer 4, a magnetic material containing an alloy such as FePt having high magnetic anisotropy as a main raw material can be used. The magnetic recording layer 4 contains an FePt alloy having high magnetic anisotropy.

The metal particle layer 5 includes metal particles 5a having an enhancing effect of the near-field light, and an inter metal particle region 5b that separates adjacent metal particles 5a. The metal particle 5a is a metal nanoparticle having a smaller size than the wavelength of light. The metal particle 5a is made of one or more types of materials selected from a group consisting of gold (Au), silver (Ag), aluminum (Al), platinum (Pt), and an alloy mainly containing at least one of these types of metals. The shape of the metal particle 5a is not limited, and may be a spherical shape or a shape having a corner. It is favorable that the metal particles 5a are arranged in a single layer in the metal particle layer 5. By the single layer arrangement of the metal particles 5a, the distance between the magnetic head 103 and the magnetic recording layer 4 can be made close, and favorable signal quality at recording/reading can be obtained. As a material of the inter metal particle region 5b, a material having small thermal conductivity is used, and for example, an insulator such as silicon oxide (SiO₂) can be used.

As a material of the overcoat layer 6, a non-magnetic material that is transparent with respect to the near-field light such as diamond like carbon (DLC) can be used.

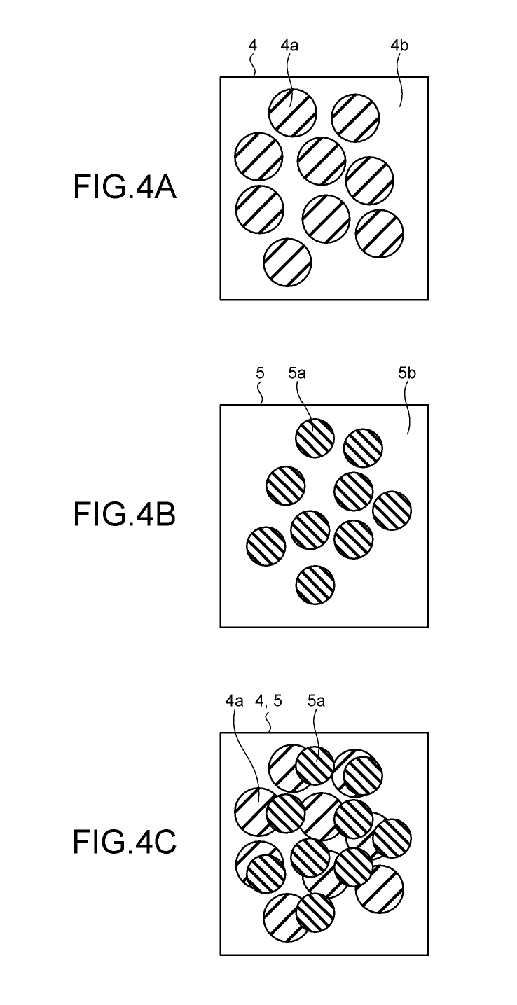

FIGS. 4A to 4C are plan views of a part of the magnetic recording layer 4 and the metal particle layer 5 in the magnetic recording medium 1 as viewed from an upper surface. FIG. 4A is a diagram illustrating an example of a state of the magnetic recording layer 4 as viewed from an upper surface. The magnetic recording layer 4 includes magnetic particles 4a and an inter magnetic particle boundary 4b that separates the adjacent magnetic particles 4a. The inter magnetic particle boundary 4b is made of carbon (C) or the like that is a non-magnetic material. FIG. 4B is a diagram illustrating an example of a state of the metal particle layer 5 as viewed from an upper surface.

FIG. 4C is a diagram illustrating an example of a relative positional relationship between the magnetic particles 4a and the metal particles 5a as viewed from an upper surface where the magnetic recording layer 4 and the metal particle layer 5 are layered in this order. FIG. 4C focuses on and illustrates the magnetic particles 4a and the metal particles 5a, and illustrates a state of transparently viewing the inter magnetic particle boundary 4b and the inter metal particle region 5b. As illustrated in FIG. 4C, the metal particles 5a are randomly arranged on the magnetic particles 4a in a dispersed manner regardless of the positions of the magnetic particles 4a.

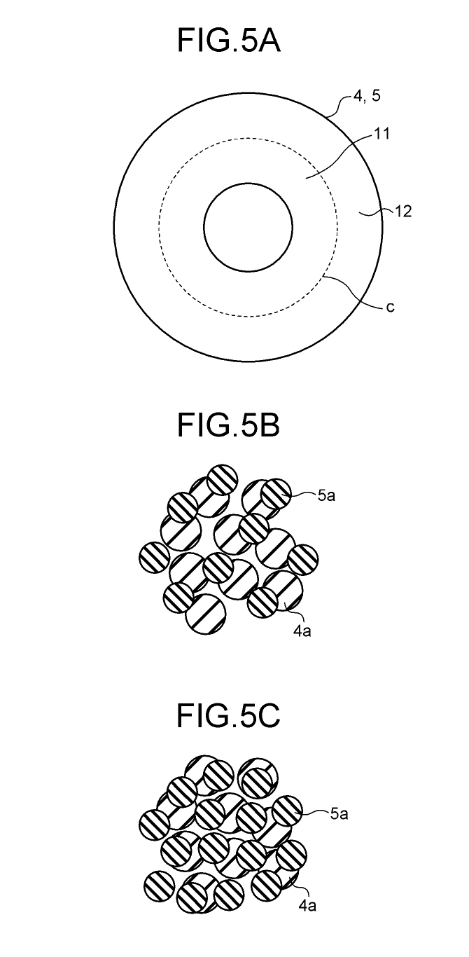

FIGS. 5A to 5C are diagrams describing a relative positional relationship between the magnetic particles 4a and the metal particles 5a in a radial position in the magnetic recording medium 1. The radial position is a position in a radial direction from the center of the magnetic recording medium. FIG. 5A is a diagram illustrating an overview of the magnetic recording medium 1 in a state in which the magnetic recording layer 4 and the metal particle layer 5 are layered in this order. FIG. 5B is a diagram illustrating a relative positional relationship between the magnetic particles 4a and the metal particles 5a in an inner periphery-side region 11 of the magnetic recording medium 1, which is a first region in the surface direction of the substrate 2. FIG. 5C is a diagram illustrating a relative positional relationship between the magnetic particles 4a and the metal particles 5a in an outer periphery-side region 12 in the magnetic recording medium 1, which is a second region in the surface direction of the substrate 2. FIGS. 5B and 5C focus on and illustrate the magnetic particles 4a and the metal particles 5a, and illustrate a state of transparently viewing the inter magnetic particle boundary 4b and the inter metal particle region 5b. The inner periphery-side region 11 is an inner periphery-side region than an intermediate position C between an outermost peripheral position and an innermost peripheral position in the radial direction of the magnetic recording medium 1. The outer periphery-side region 12 is an outer periphery-side region than the intermediate position C between the outermost peripheral position and the innermost peripheral position in the radial direction of the magnetic recording medium 1.

As illustrated in FIG. 5C, a gap between particles of the magnetic particles 4a in the outer periphery-side region 12 is equal to a gap between particles of the magnetic particles 4a in the inner periphery-side region 11. Meanwhile, a gap between particles of the metal particle 5a in the outer periphery-side region 12 is narrower than a gap between particles of the metal particles 5a in the inner periphery-side region 11. That is, in the metal particle layer 5, percentage content of the metal particles 5a in the outer periphery-side region 12 is higher than that of the metal particles 5a in the inner periphery-side region 11.

Next, an action of the metal particle layer 5 in the magnetic recording medium 1 will be described. When the metal nanoparticles are placed in an electric field (light), a free electron in the metal nanoparticles resonates by an oscillating electric field of light, and large polarization (localized plasmon) is induced in the metal nanoparticles. As a result, the electric field around the metal nanoparticle is reinforced. In the present specification, the “reinforcement of the electric field around the metal nanoparticles” by the localized plasmon is written as “reinforcement of the near-field light”.

The energy of the electric field serves as a heating source of surrounding substances. Therefore, when the electric field around the metal nanoparticles placed in the light is reinforced, the substances around the metal nanoparticles that receive the light are heated by the energy of the reinforced electric field.

That is, in the magnetic recording medium 1, when the metal particles 5a as the metal nanoparticles are irradiated with the near-field light converted from the laser light, the electric field around the metal particles 5a is reinforced. The magnetic recording layer 4 around the metal particles 5a irradiated with the near-field light is locally heated by the energy of the enhanced electric field around the metal particles 5a and is increased in temperature, and enters a state in which the coercivity is decreased. Then, a magnetic field is applied to a region of the magnetic recording layer 4 in which the coercivity is decreased, so that the magnetization of the region is reversed, and information is recorded.

Accordingly, in the magnetic recording medium 1, the magnetic recording layer 4 is efficiently heated, and the coercivity can be decreased. That is, in the magnetic recording medium 1, a laser light output necessary for heating the magnetic recording layer 4 to a desired temperature can be reduced, and a micro region of the magnetic recording layer 4 can be efficiently heated by a small laser light output. In addition, since the laser light output is small, a spot diameter of the converted near-field light can be made small, only a desired micro region in the magnetic recording layer 4 can be reliably heated. Further, only the micro region is heated, the micro region can be promptly cooled after recording. Further, the magnetic recording layer 4 is positioned in a lower layer of the metal particle layer 5. Therefore, the heat of the magnetic recording layer 4 heated by the metal particle layer 5 can be easily spread in a substrate direction. Therefore, the micro region heated in the magnetic recording layer 4 can be promptly cooled after recording.

Here, in the heat assisted magnetic recording device, to rotate the magnetic recording medium at a certain rotation speed, a relative speed between the recording head and the magnetic recording medium varies according to a radial position. The heating energy received by the magnetic recording medium from the near-field light is a product of an output of a laser oscillated from the laser light source per unit time and a time in which the near-field light is applied. Therefore, the energy received by a unit area of the magnetic recording medium from the near-field light is different depending on the radial position if, the output of the laser is constant.

That is, in the outer periphery-side region of the magnetic recording medium, the relative speed between the recording head and the magnetic recording medium is large. Meanwhile, in the inner periphery-side region of the magnetic recording medium, the relative speed between the recording head and the magnetic recording medium is small. Therefore, the heating energy received by the unit area of the outer periphery-side region of the magnetic recording medium is relatively smaller than the heating energy received by the unit area of the inner periphery-side region of the magnetic recording medium.

To deal with that, there is a method of adjusting a laser light output according to the radial position of the magnetic recording medium, such as increasing the laser light output in the outer periphery-side region of the magnetic recording medium than the laser light output in the inner-periphery side region of the magnetic recording medium. However, in this case, processing of changing the laser light output, a time to wait for stability of the laser light output after the change of the laser light output, and the like are necessary. Since the efficiency of converting the laser light into the near-field light is low, most of the energy of the laser light is converted into heat. The heat has an adverse effect on the lifetime of the recording head, and deterioration of the recording head is progressed. Therefore, an increase in a laser light output leads to the deterioration of the recording head.

Therefore, in the magnetic recording medium 1, the percentage content of the metal particles 5a in the outer periphery-side region 12 of the metal particle layer 5 is higher than that of the metal particles 5a in the inner periphery-side region 11 of the metal particle layer 5. Therefore, an enhancing effect of the near-field light generated in the outer periphery-side region 12 becomes larger than that of the inner periphery-side region 11. Accordingly, a difference due to the radial direction of the laser light output necessary in the inner periphery-side region 11 and the outer periphery-side region 12 in recording of information can be made small without increasing the laser light output in the outer periphery-side region 12. That is, the laser light output necessary for heating the outer periphery-side region 12 of the magnetic recording layer 4 to a desired temperature can be further decreased, and the magnetic recording layer 4 can be efficiently heated by a smaller laser light output.

Further, in the magnetic recording medium 1, the magnetic recording layer 4 can be efficiently heated by a smaller laser light output, and therefore, heating of a region of the magnetic recording layer 4, which is not necessary to be heated because of spread of the near-field light caused by an increase in laser light output, can be prevented. That is, only a predetermined micro region in which information is to be recorded is locally heated, and is then promptly cooled. Accordingly, loss of the information recorded in the magnetic particles 4a in which the information is recorded and in the surrounding magnetic particles 4a in the magnetic recording layer 4 can be prevented.

Therefore, in the recording of information in the magnetic recording medium 1, the deterioration of the lifetime of the magnetic head 103 caused by the laser light output can be suppressed, and the lifetime prolongation of the magnetic head 103 can be realized. In addition, a decrease in power consumption of the magnetic recording device 100 can be realized.

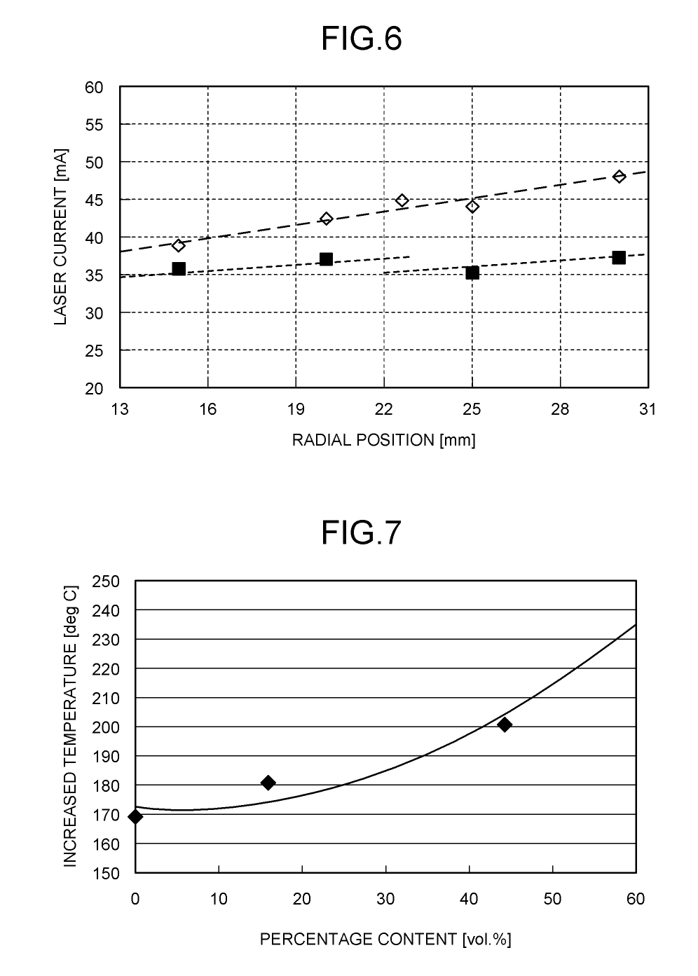

FIG. 6 is a characteristic diagram illustrating a relationship between a laser current necessary for obtaining a predetermined SNR and the radial position in the magnetic recording medium in a magnetic recording medium (comparative example) having the same configuration as the magnetic recording medium 1 other than not including the metal particle layer 5 and the magnetic recording medium 1 (embodiment) according to the first embodiment. In FIG. 6, the radial position [mm] in the magnetic recording medium is represented by the horizontal axis, and the laser current [mA] is represented by the vertical axis. The laser current is a current necessary for realizing a predetermined laser output in the laser light source 111. Further, in FIG. 6, a result of the comparative example is indicated by the ⋄ (rhombus) mark, and a result of the embodiment is indicated by the black □ (square) mark.

As illustrated in FIG. 6, in the embodiment, the laser current at heating by the near-field light necessary for obtaining a predetermined SNR can be decreased without depending on the radial position compared with the comparative example. Further, the dependency of the necessary laser current on the radial position in the embodiment is smaller than the comparative example.

From the above, the necessary laser current can be decreased when the metal particle layer 5 is included. When the percentage content of the metal articles 5a in the outer periphery-side region 12 of the metal particle layer 5 is set higher than that of the metal particles 5a in the inner periphery-side region 11, a difference of the necessary laser current due to the radial position between the inner periphery-side region 11 and the outer periphery-side region 12 can be made small, and the laser light output necessary in the outer periphery-side region 12 can be decreased.

FIG. 7 is a characteristic diagram illustrating a relationship between the percentage content [vol. %] of the metal particles 5a in the metal particle layer 5 of the magnetic recording medium 1 and an increased temperature [deg C] at heating of the magnetic recording medium 1 by the near-field light. In FIG. 7, the percentage content [vol. %] of the metal particles 5a in the metal particle layer 5 is represented by the horizontal axis, and the increased temperature [deg C] is represented by the vertical axis. The percentage content and the increased temperature are in a particular radial position in the magnetic recording medium 1. Further, the increased temperature of the magnetic recording medium 1 is a result of a temperature increase of the magnetic recording medium 1 under a condition in which the heating energy provided by the magnetic head 103 in a unit time is constant, which is obtained by an optical analysis and a thermal analysis by computer simulation.

As illustrated in FIG. 7, an increased amount of the temperature of the magnetic recording medium 1 becomes large by increasing the percentage content of the metal particles 5a. Therefore, it can be understood that the dependency of the necessary laser current on the radial position can be decreased by the percentage content of the metal particles 5a in the outer periphery-side region 12 of the metal particle layer 5 being set higher than that of the metal particles 5a in the inner periphery-side region 11, thereby making it possible to decrease the necessary laser current.

Note that, in the above description, a case has been illustrated, in which the percentage content of the metal particles 5a in the outer periphery-side region 12 is higher than that of the metal particles 5a in the inner periphery-side region 11. However, the number of divisions in the radial direction of the metal particle layer 5 is not limited to two. The metal particle layer 5 is further divided into a large number of regions in the radial direction, and the percentage content of the metal particles 5a in the outer periphery-side region is set higher than that of the metal particles 5a in the inner periphery-side region, whereby the above-described effect can be obtained.

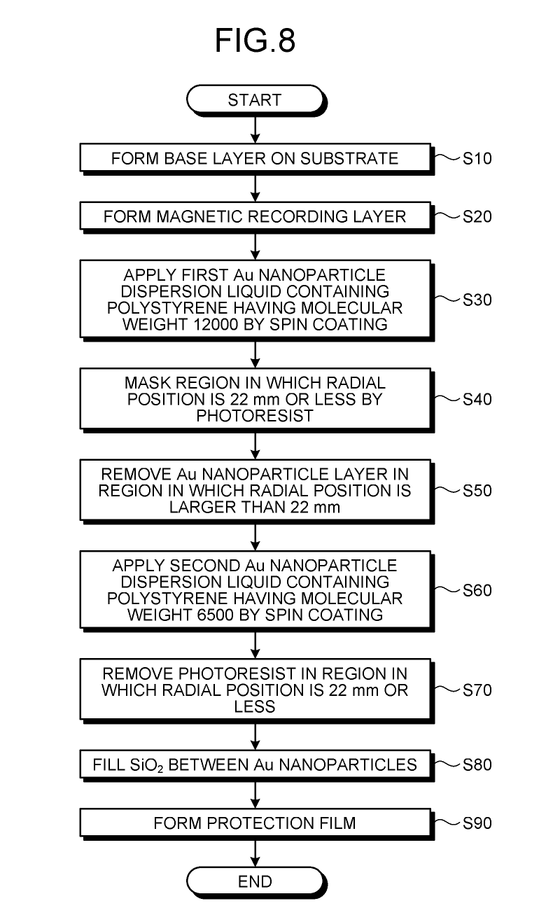

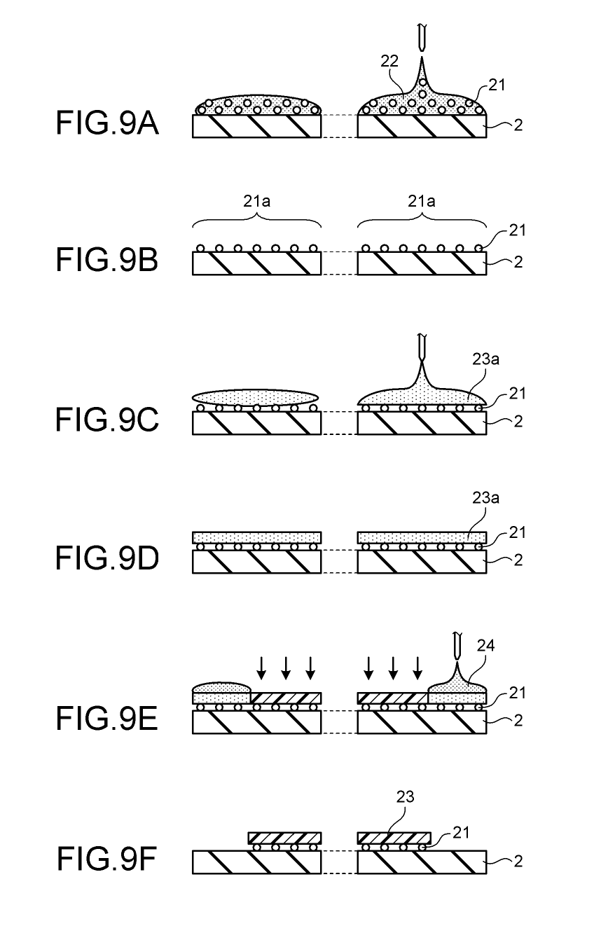

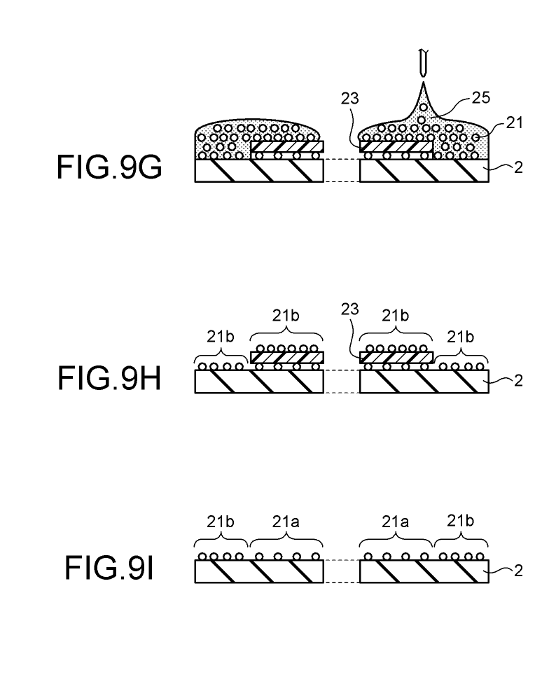

Next, an example of a method of manufacturing the magnetic recording medium 1 will be described. FIG. 8 is a flowchart illustrating a procedure of an example of a method of manufacturing the magnetic recording medium 1. FIGS. 9A to 9I are cross sectional views illustrating processes of forming the metal particle layer 5 in the example of the method of manufacturing the magnetic recording medium 1. FIGS. 9A to 9I illustrate a cross section in the line segment A-A of FIG. 3A. Further, in FIGS. 9A to 9I, description of the underlayer 3 and the magnetic recording layer 4 is omitted.

First, the underlayer 3 made of an MgO film having a film thickness of 10 nm is formed on one surface of the disk-like (doughnut-like) substrate 2 under a condition of an RF output: 800 W, an argon (Ar) gas pressure: one Pa, and a film forming time: five seconds by a sputtering method, for example (step S10).

Next, the magnetic recording layer 4 having a film thickness of 6 nm is formed on the underlayer 3 under a condition of a DC output: 1000 W, a substrate temperature: 500° C., the argon (Ar) gas pressure: one Pa, and the film forming time: five seconds by a sputtering method using an FePt-carbon (C) composite target, for example (step S20). The formed magnetic recording layer 4 is made of an FePt—C granular thin film having a granular structure including the FePt magnetic particles 4a in which an average particle diameter is about 10 nm, and the inter magnetic particle boundary 4b made of carbon (C) and provided between adjacent magnetic particles 4a.

Next, a dispersion liquid (first nanoparticle dispersion liquid 22) containing polystyrene having a molecular weight 12000 and gold (Au) nanoparticles 21 that serves as the metal particles 5a is prepared using toluene as a dispersion medium. The average particle diameter of the Gold (Au) nanoparticle 21 is 10 nm. Then, the first nanoparticle dispersion liquid 22 is dropped onto the magnetic recording layer 4 (FIG. 9A), and is applied on the magnetic recording layer 4 by a spin coat method, so that a first Au single layer arrangement 21a that is a layer in which the gold (Au) nanoparticles 21 are arranged as a single layer can be obtained (step S30, FIG. 9B).

Note that, in the dispersion liquid in which polystyrene and the metal nanoparticles such as Au are dispersed in an organic solvent such as toluene, the metal nanoparticles having a protective group made of a polymer chain (polystyrene) on a surface is dispersed in the organic solvent. With the existence of the protective group, the metal nanoparticles can maintain a certain distance from a plurality of adjacent metal nanoparticles in the solvent. A certain distance can be adjusted by a molecular weight of the polymer chain. Under a state in which such a dispersion liquid is applied on the substrate by spin coating and the metal nanoparticles are arranged, the polymer chain (protective group) remains around the metal nanoparticle. That is, the first Au single layer arrangement 21a is configured such that the protective group made of polystyrene remains around the gold (Au) nanoparticle 21.

The particle diameter of the gold (Au) nanoparticle 21 is about 10 nm, similarly to the magnetic particle 4a, for example. For example, in a case of a 2.5-inch magnetic recording medium 1, a minimum length of a signal bit to be recorded is about 10 nm. In this case, the particle diameter of the metal particle 5a is about 7 to 15 nm that is about the minimum length of a signal bit so that one metal particle 5a does not overlap with three or more preceding and subsequent signal bits.

By causing the particle diameter of the metal particle 5a to be small, unevenness of the percentage content of the metal particles 5a in the surface direction of the metal particle layer 5, that is, occurrence of unevenness in the dispersed arrangement is suppressed. Accordingly, unevenness of a heating effect caused by the arrangement of the metal particles 5a in the surface direction of the metal particle layer 5 is suppressed. Note that, when the gold (Au) nanoparticles 21 (metal particles 5a) aggregate, the particle diameter of the aggregate as a whole is caused to be about the minimum length of the signal bit.

Next, a region in which a radial position on the magnetic recording layer 4 on which the first Au single layer arrangement 21a is formed is 22 mm or less is masked by a photoresist (step S40). First, a negative-type photoresist 23a is dropped onto the magnetic recording layer 4 on which the first Au single layer arrangement 21a is formed (FIG. 9C), and is applied on the magnetic recording layer 4 by the spin coat method (FIG. 9D).

Next, exposure is performed to the region in which the radial position that is an inner periphery-side region of the substrate 2 in the photoresist 23a is 22 mm or less. Then, a solvent 24 such as toluene is supplied on the photoresist 23a arranged at a region that is an outer periphery-side region of the substrate 2, and in which the radial position is larger than 22 mm (FIG. 9E), and an outer periphery-side regions of the photoresist 23a and of the first Au single layer arrangement 21a are removed by dissolving (step S50, FIG. 9F). Note that the protective group made of polystyrene existing between the gold (Au) nanoparticles 21 of the first Au single layer arrangement 21a is removed by dissolving by the solvent 24, so that the arrangement of the gold (Au) nanoparticles 21 is broken and removed. Accordingly, the photoresist mask 23 and the first Au single layer arrangement 21a are arranged only on an inner periphery-side region of the magnetic recording layer 4. Further, the outer periphery-side region of the magnetic recording layer 4 is exposed.

Next, a dispersion liquid (second nanoparticle dispersion liquid 25) including polystyrene having a molecular weight 6500 and the gold (Au) nanoparticle 21 is prepared using toluene as a dispersion medium. The average particle diameter of the gold (Au) nanoparticle 21 is 10 nm that is the same as the first nanoparticle dispersion liquid 22. The second nanoparticle dispersion liquid 25 is then dropped onto one surface of the substrate 2 (FIG. 9G), and is applied by the spin coat method (step S60). Accordingly, a second Au single layer arrangement 21b can be obtained, which is a layer in which the gold (Au) nanoparticles 21 are arranged on the outer periphery-side region and on the photoresist mask 23 on the magnetic recording layer 4 as a single layer (FIG. 9H). In the second Au single layer arrangement 21b, the gold (Au) nanoparticles 21 are arranged in a dispersed manner in a state in which the percentage content is higher than the first Au single layer arrangement 21a. The second Au single layer arrangement 21b is configured such that the protective group made of polystyrene remains around the gold (Au) nanoparticle 21.

Next, the photoresist mask 23 on a region in which the radial position on the magnetic recording layer 4 is 22 mm or less is lifted off, and the photoresist mask 23 and the second Au single layer arrangement 21b on the photoresist mask 23 are removed (step S70). Accordingly, the first Au single layer arrangement 21a is arranged on a region that is an inner periphery-side region on the magnetic recording layer 4, and in which the radial position is 22 mm or less (FIG. 9I). Further, the second Au single layer arrangement 21b is arranged on a region that is an outer periphery-side region on the magnetic recording layer 4, and in which the radial position is larger than 22 mm (FIG. 9I).

Next, sputtering is performed under a condition of the RF output: 100 W, the argon (Ar) gas pressure: one Pa, and the film forming time: 10 seconds, using a silicon oxide (SiO₂) target, for example. Accordingly, the silicon oxide (SiO₂) is filled between particles of adjacent gold (Au) nanoparticles 21 in the first Au single layer arrangement 21a and in the second Au single layer arrangement 21b, and the metal particle layer 5 is formed (step S80).

Then the overcoat layer 6 made of diamond like carbon is formed on the metal particle layer 5 by a sputtering method (step S90). By conducting of the above processes, the magnetic recording medium 1 can be obtained.

The metal particle layer 5 of the magnetic recording medium 1 manufactured by the manufacturing method according to the first embodiment is observed by a transmission electron microscope (TEM), and an average gap between particles of the metal particles 5a is obtained. As a result, the average gap between particles of the metal particles 5a in the inner periphery-side region where the radial position is 22 mm or less is 10 nm, and the average gap between particles of the metal particles 5a in the outer periphery-side region where the radial position is larger than 22 mm is 6 mm. As described above, the distance between the metal particles 5a can be changed by changing the molecular weight of polystyrene of the first nanoparticle dispersion liquid 22 and the second nanoparticle dispersion liquid 25. Therefore, by manufacturing the magnetic recording medium 1 under the above-described conditions, the metal particles 5a can be arranged with the average gap between particles of the above value.

As described above, according to the first embodiment, the magnetic recording medium 1 includes the metal particle layer 5. As a result, in the magnetic recording medium 1, an effect of efficiently heating the magnetic recording layer 4 by a small laser light output can be obtained.

Further, according to the first embodiment, the percentage content of the metal particles 5a in the outer periphery-side region 12 of the metal particle layer 5 is higher than that of the metal particles 5a in the inner periphery-side region 11 of the metal particle layer 5. As a result, in the magnetic recording medium 1, an effect of effectively heating the outer periphery-side region 12 of the magnetic recording layer 4 by a smaller laser light output can be obtained.

Therefore, according to the first embodiment, an effect of suppressing deterioration of a lifetime of the magnetic head 103 due to a laser light output and realizing lifetime prolongation of the magnetic head 103 can be obtained. Further, according to the first embodiment, an effect of realizing a decrease in power consumption of the magnetic recording device 100 can be obtained.

### Second Embodiment

In a second embodiment, another example of a method of manufacturing a metal particle layer 5 will be described.

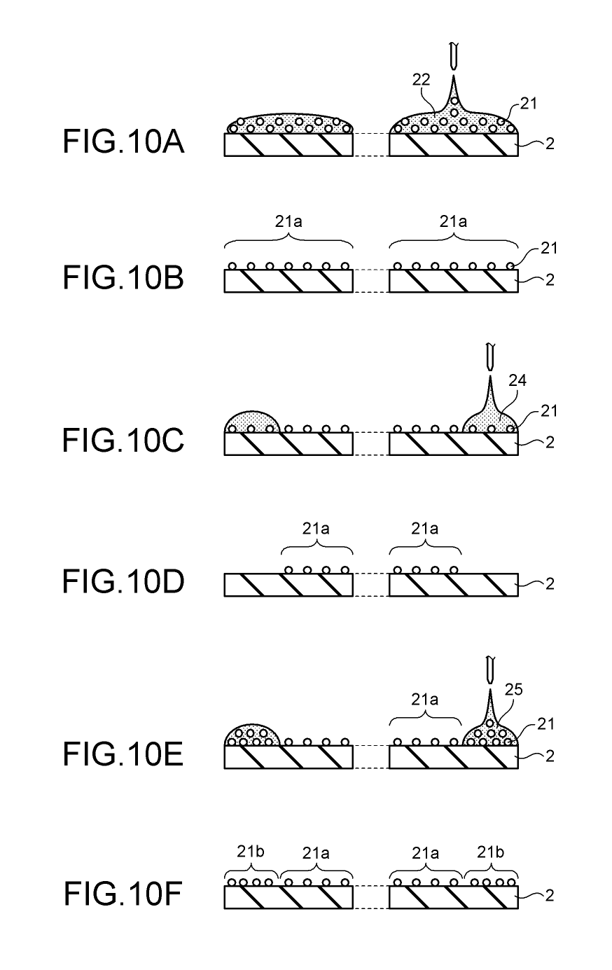

FIGS. 10A to 10F are cross sectional views illustrating processes of a method of manufacturing the metal particle layer 5 according to the second embodiment. A different point of the method of manufacturing the metal particle layer 5 according to the second embodiment from the method of manufacturing the metal particle layer 5 according to the first embodiment is that the first Au single layer arrangement 21a formed on a region in which a radial position is larger than 22 mm is removed without forming a mask by a photoresist.

First, similarly to the first embodiment, a processes from a process of forming the underlayer 3 to a process of forming the first Au single layer arrangement 21a illustrated in FIG. 9B are performed (FIGS. 10A and 10B).

Next, the solvent 24 such as toluene is supplied on the first Au single layer arrangement 21a arranged on a region in which the radial position is larger than 22 mm (FIG. 10C), and the first Au single layer arrangement 21a arranged on the region in which the radial position is larger than 22 mm is removed (FIG. 10D). Accordingly, the first Au single layer arrangement 21a is arranged only on a region that is an inner periphery-side region and in which the radial position is 22 mm or less on the magnetic recording layer 4.

Next, a dispersion liquid (second nanoparticle dispersion liquid 25) containing polystyrene having a molecular weight 6500 and gold (Au) nanoparticles 21 is prepared using toluene as a dispersion medium. Then, the second nanoparticle dispersion liquid 25 is dropped onto a region that is an outer periphery-side region and in which the radial position is larger than 22 mm on the magnetic recording layer 4 (FIG. 10E), and is applied by a spin coat method. Accordingly, the second Au single layer arrangement 21b can be obtained on the region that is an outer periphery-side region and in which the radial position is larger than 22 mm on the magnetic recording layer 4 (FIG. 10F).

By performing the above processes, the first Au single layer arrangement 21a is arranged on a region that is an inner periphery-side region and in which the radial position is 22 mm or less on the magnetic recording layer 4. Further, the second Au single layer arrangement 21b is arranged on a region that is an outer periphery-side region and in which the radial position is larger than 22 mm on the magnetic recording layer 4. Then, in the second Au single layer arrangement 21b, the gold (Au) nanoparticles 21 are arranged in a dispersed manner in a state in which the percentage content is higher than the first Au single layer arrangement 21a. Accordingly, formation of a photoresist mask 23 is not necessary, and the metal particle layer 5 can be more easily formed than the first embodiment.

As described above, according to the second embodiment, the first Au single layer arrangement 21a formed on the region in which the radial position is larger than 22 mm is removed without forming a mask by a photoresist. As a result, an effect of forming the metal particle layer 5 by easy processes can be obtained.

### Third Embodiment

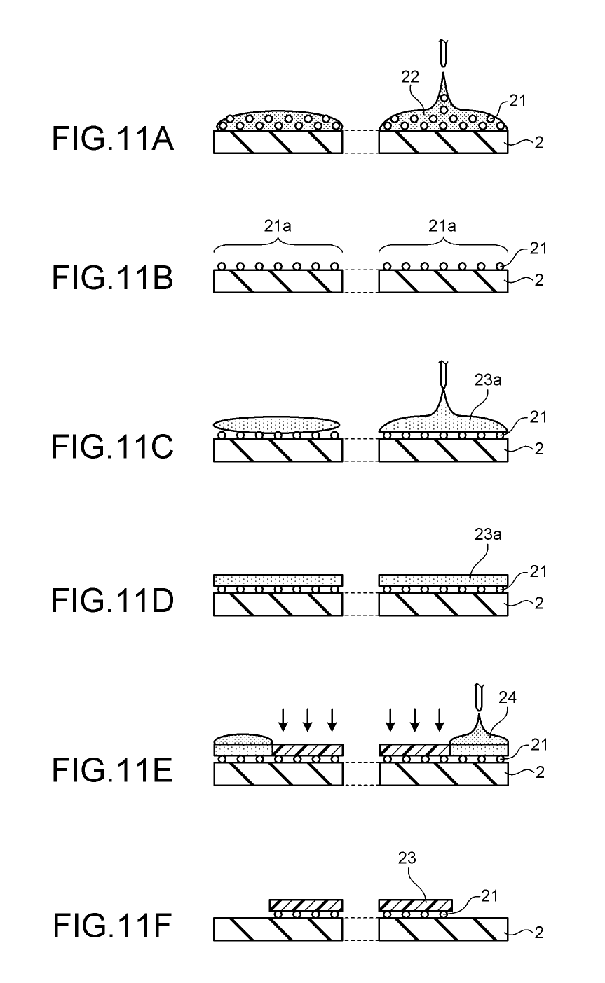

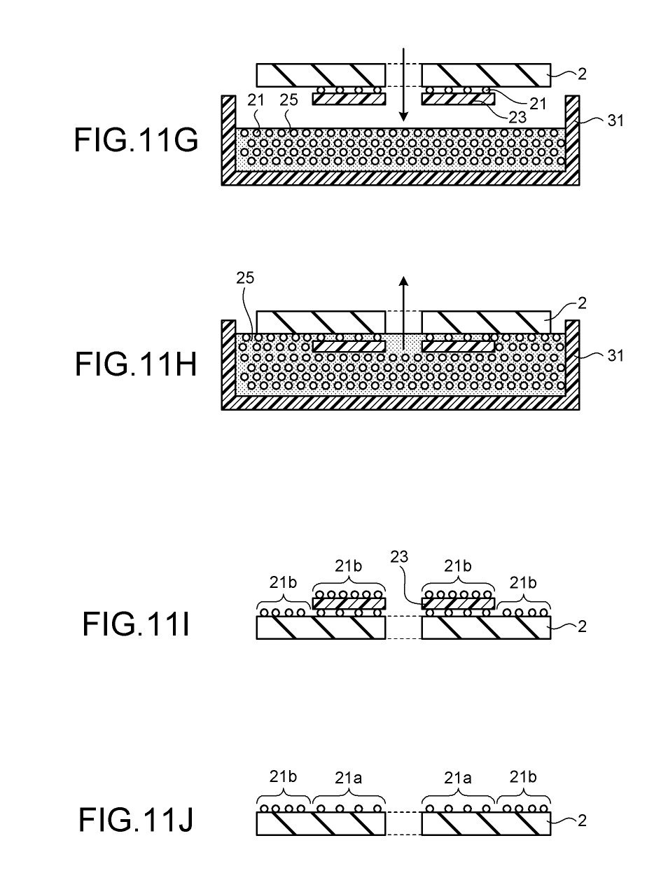

In a third embodiment, another example of a method of manufacturing the metal particle layer 5 will be described. FIGS. 11A to 11J are cross sectional views illustrating processes of a method of manufacturing the metal particle layer 5 according to the third embodiment. A different point of the method of manufacturing the metal particle layer 5 according to the third embodiment from the method of manufacturing the metal particle layer 5 according to the first embodiment is that a surface of one surface side of the substrate 2 after formation of the photoresist mask 23 is attached to the second nanoparticle dispersion liquid 25 and the substrate 2 is then pulled out, so that a second Au single layer arrangement 21b is arranged on a region in which a radial position is larger than 22 mm.

First, similarly to the first embodiment, a process of forming an underlayer 3 to a process of removing the photoresist 23a and the first Au single layer arrangement 21a by dissolving illustrated in FIG. 9F are performed. Accordingly, the photoresist mask 23 and the first Au single layer arrangement 21a are arranged only on a region that is an inner periphery-side region and in which the radial position is 22 mm or less, on a magnetic recording layer 4 (FIGS. 11A to 11F).

Next, on the substrate 2, the surface on which the photoresist mask 23 has been formed is attached to the second nanoparticle dispersion liquid 25 accumulated in a treatment tank 31, and a surface of the photoresist 23a and an exposed surface of the magnetic recording layer 4 are attached to the second nanoparticle dispersion liquid 25. Following that, by pulling out the substrate 2, the surface of the photoresist 23a and the surface of the magnetic recording layer 4 are separated from the second nanoparticle dispersion liquid 25 (FIGS. 11G and 11H). Then, after toluene in the second nanoparticle dispersion liquid 25 is volatilized, the substrate 2 is turned over. Accordingly, on the magnetic recording layer 4, the second Au single layer arrangement 21b that is a gold (Au) nanoparticle layer is obtained on a region that is an outer periphery-side region and in which the radial position is larger than 22 mm and on the photoresist mask 23 (FIG. 11I). In the second Au single layer arrangement 21b, the gold (Au) nanoparticles 21 are arranged in a dispersed manner in a state in which the percentage content is higher than the first Au single layer arrangement 21a.

Next, similarly to the first embodiment, the photoresist mask 23 on the region in which the radial position is 22 mm or less on the magnetic recording layer 4 is lifted off, and the photoresist mask 23 and the second Au single layer arrangement 21b on the photoresist mask 23 are removed (FIG. 11J).

By performing the above processes, the first Au single layer arrangement 21a is arranged on a region that is an inner periphery-side region and in which the radial position is 22 mm or less on the magnetic recording layer 4. Further, the second Au single layer arrangement 21b is arranged on the region that is an outer periphery-side region and in which the radial position is larger than 22 mm on the magnetic recording layer 4. Then, in the second Au single layer arrangement 21b, the gold (Au) nanoparticles 21 are arranged in a dispersed manner in a state in which the percentage content is higher than the first Au single layer arrangement 21a. Accordingly, the process of forming the second Au single layer arrangement 21b is simplified, and the metal particle layer 5 can be more easily formed than the first embodiment.

As described above, according to the third embodiment, the surface of one surface side of the substrate 2 after the formation of the photoresist mask 23 is attached to the second nanoparticle dispersion liquid 25, and the second Au single layer arrangement 21b is formed. As a result, an effect of forming the metal particle layer 5 by more easy processes can be obtained.

### Fourth Embodiment

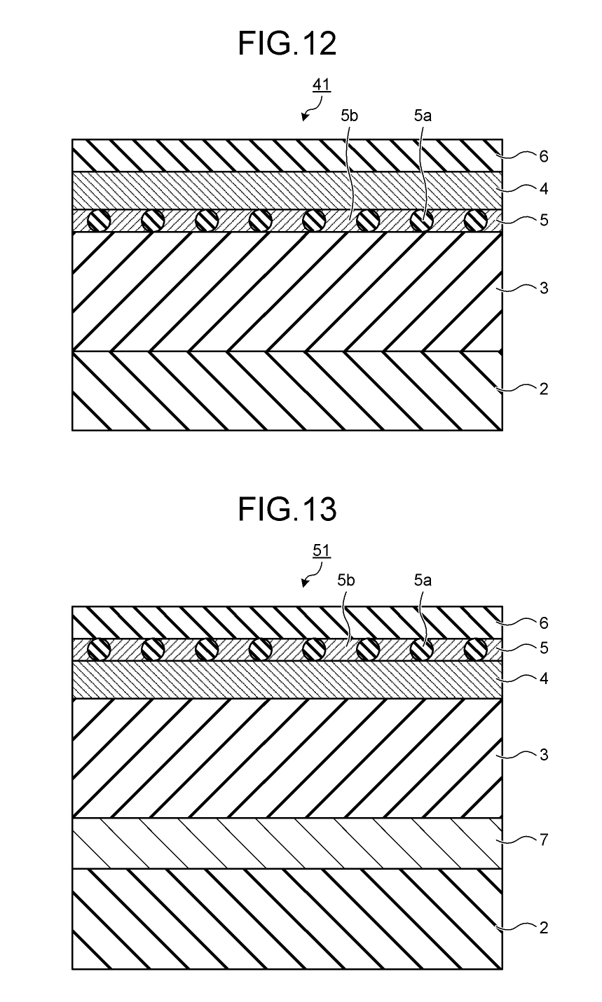

FIG. 12 is a cross sectional view of a part of a magnetic recording medium 41 according to a fourth embodiment. A different point of a magnetic recording medium 41 according to the fourth embodiment from the magnetic recording medium 1 according to the first embodiment is that the magnetic recording layer 4 is arranged on the metal particle layer 5. That is, in the magnetic recording medium 41, the underlayer 3, the metal particle layer 5, the magnetic recording layer 4, and the overcoat layer 6 are arranged on one surface of the substrate 2 in this order.

In the magnetic recording medium 41, the distance between a magnetic head and the magnetic recording layer 4 is shorter than the magnetic recording medium 1 according to the first embodiment while it depends on conditions of the magnetic head and the magnetic recording layer 4. Therefore, favorable signal quality at recording/reading can be obtained. Note that the magnetic recording medium 41 can obtain, similarly to the first embodiment, the effect that can be obtained because the metal particle layer 5 is included.

As described above, according to the fourth embodiment, the magnetic recording layer 4 is arranged on the metal particle layer 5. As a result, an effect of obtaining favorable signal quality at recording/reading can be obtained.

### Fifth Embodiment

FIG. 13 is a cross sectional view of a part of a magnetic recording medium 51 according to a fifth embodiment. A different point of the magnetic recording medium 51 according to the fifth embodiment from the magnetic recording medium 1 according to the first embodiment is that a heat sink layer 7 is provided between the substrate 2 and the underlayer 3. That is, in the magnetic recording medium 51, the heat sink layer 7, the underlayer 3, the magnetic recording layer 4, the metal particle layer 5, and the overcoat layer 6 are provided on one surface of the substrate 2 in this order.

In the magnetic recording layer 4, if magnetic particles 4a that have been heated and in which information has been recorded are kept in a high temperature state, thermal stability of the magnetic particles 4a in which the information is recorded and the surrounding magnetic particles 4a is decreased, and the recorded information may be deteriorated or lost.

The heat sink layer 7 is made of, for example, a material having high heat conductivity than the magnetic recording layer 4 such as silver (Ag). After recording by the magnetic head 103, the heat sink layer 7 can absorb and cool heat accumulated in the magnetic recording layer 4 of the magnetic recording medium 51. Such the heat sink layer 7 can be formed by a sputtering method, for example.

The magnetic recording medium 51 includes the heat sink layer 7. Therefore, the magnetic recording medium 51 can suppress spread of the heat in a surface direction, can prevent the decrease in thermal stability of magnetic particles 4a due to the heat of the magnetic particles 4a, and can prevent the deterioration or loss of the recorded information. Further, the magnetic recording medium 51 can obtain, similarly to the first embodiment, the effect that can be obtained because the metal particle layer 5 is included.

As described above, according to the fifth embodiment, the heat sink layer 7 is provided on one surface of the substrate 2. As a result, the heat accumulated in the magnetic recording layer 4 of the magnetic recording medium 51 at recording can be promptly absorbed and cooled, and an effect of preventing deterioration and loss of recorded information can be obtained.

### Sixth Embodiment

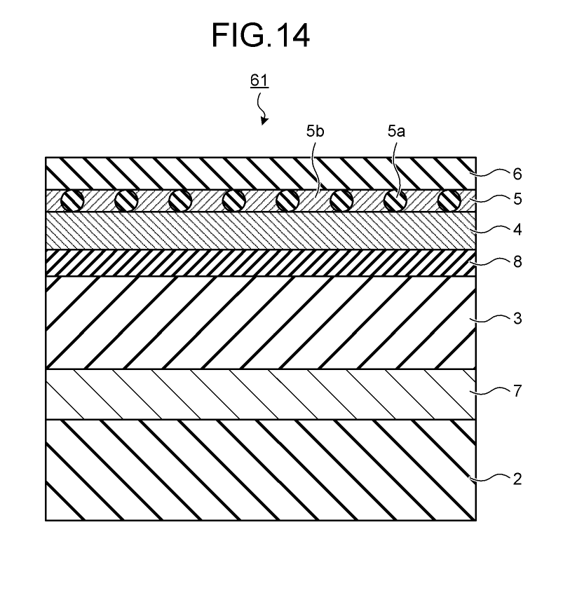

FIG. 14 is a cross sectional view of a part of a magnetic recording medium 61 according to a sixth embodiment. The magnetic recording medium 61 according to the sixth embodiment is a modification of the magnetic recording medium 51 according to the fifth embodiment. A different point of the magnetic recording medium 61 according to the sixth embodiment from the magnetic recording medium 51 according to the fifth embodiment is that a heat barrier layer 8 is provided between the underlayer 3 and the magnetic recording layer 4. That is, in the magnetic recording medium 61, the heat sink layer 7, the underlayer 3, the heat barrier layer 8, the magnetic recording layer 4, the metal particle layer 5, and the overcoat layer 6 are arranged on one surface of the substrate 2 in this order.

The heat barrier layer 8 is made of a material having lower heat conductivity than the magnetic recording layer 4, such as zirconium dioxide (ZrO₂). The heat barrier layer 8 can suppress thermal diffusion to lower layers from the magnetic recording layer 4, and efficiently increase the temperature of the magnetic recording layer 4 by irradiation of the near-field light at recording. Such a heat barrier layer 8 can be formed by a sputtering method, for example.

The magnetic recording medium 61 includes the heat barrier layer 8, the magnetic recording medium 61 can efficiently increase the temperature of the magnetic recording layer 4 by the irradiation of near-field light or the like at recording, and therefore, the magnetic recording medium 61 can heat the magnetic recording layer 4 to a higher temperature. Note that the above effect can be obtained even if the heat sink layer 7 is not provided.

As described above, according to the sixth embodiment, the heat barrier layer 8 is provided between the underlayer 3 and the magnetic recording layer 4. As a result, the temperature of the magnetic recording layer 4 can be efficiently increased by the irradiation of the near-field light at recording, and therefore, an effect of heating the magnetic recording layer 4 to a higher temperature can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A magnetic recording medium used in a heat assisted magnetic recording system, comprising:
a magnetic recording layer and a metal particle layer in which metal particles are separated to each other and arranged in a dispersed manner above a substrate,
wherein, in the metal particle layer, percentage content of the metal particles in a second region positioned at an outer periphery side of a first region is higher than percentage content of the metal particles in the first region in a surface direction of the substrate.

2. The magnetic recording medium according to claim 1, wherein the metal particle is made of one or more materials selected from a group consisting of gold, silver, aluminum, platinum, and an alloy mainly containing at least one of these types of metals.

3. The magnetic recording medium according to claim 1, wherein a heat sink layer made of a material having higher heat conductivity than the magnetic recording layer is provided between the substrate and the magnetic recording layer.

4. The magnetic recording medium according to claim 1, wherein a heat barrier layer made of a material having lower heat conductivity than the magnetic recording layer is provided between the substrate and the magnetic recording layer.

5. The magnetic recording medium according to claim 2, wherein a heat sink layer made of a material having higher heat conductivity than the magnetic recording layer is provided between the substrate and the magnetic recording layer.

6. The magnetic recording medium according to claim 2, wherein a heat barrier layer made of a material having lower heat conductivity than the magnetic recording layer is provided between the substrate and the magnetic recording layer.

7. The magnetic recording medium according to claim 3, wherein a heat barrier layer made of a material having lower heat conductivity than the magnetic recording layer is provided between the substrate and the magnetic recording layer.

8. The magnetic recording medium according to claim 5, wherein a heat barrier layer made of a material having lower heat conductivity than the magnetic recording layer is provided between the substrate and the magnetic recording layer.

9. A method of manufacturing a magnetic recording medium, comprising:
forming a magnetic recording layer and a metal particle layer in which metal particles are arranged in a dispersed manner as upper layers of a substrate,
wherein, causing, in a surface direction of the substrate, percentage content of the metal particles in the metal particle layer of a second region positioned at an outer periphery side of a first region to be higher than percentage content of the metal particles in the metal particle layer of the first region.

10. The method of manufacturing the magnetic recording medium according to claim 9, comprising:
forming the magnetic recording layer as an upper layer of the substrate;
forming a first metal particle arrangement in which the metal particles are arranged in a dispersed manner and a mask layer on the first region of the magnetic recording layer in this order, and exposing the second region of the magnetic recording layer;
forming, on the magnetic recording layer of the second region and the mask layer, a second metal particle arrangement in which the metal particles are arranged in a dispersed manner at higher percentage content than the first metal particle arrangement in a surface direction of the substrate; and
removing the mask layer and the second metal particle arrangement on the mask layer by lifting off the mask layer.

11. The method of manufacturing the magnetic recording medium according to claim 10, wherein the second metal particle arrangement is formed by a dispersion liquid in which polystyrene and the metal particles are dispersed in a volatile dispersion medium being dropped onto the magnetic recording layer of the second region and the mask layer.

12. The method of manufacturing the magnetic recording medium according to claim 11, wherein a gap length between adjacent metal particles in the second metal particle arrangement is set shorter than that in the first metal particle arrangement by adjustment of a molecular weight of the polystyrene.

13. The method of manufacturing the magnetic recording medium according to claim 10, wherein the second metal particle arrangement is formed such that, after a surface of the magnetic recording layer of the second region and a surface of the mask layer are attached to a dispersion liquid in which polystyrene and the metal particles are dispersed in a volatile dispersion medium, the surface of the magnetic recording layer and the surface of the mask layer are separated from the dispersion liquid.

14. The method of manufacturing the magnetic recording medium according to claim 13, wherein a gap length between adjacent metal particles in the second metal particle arrangement is set shorter than that in the first metal particle arrangement by adjustment of a molecular weight of the polystyrene.

15. The method of manufacturing the magnetic recording medium according to claim 9, comprising:
forming the magnetic recording layer as an upper layer of the substrate;
forming a third metal particle arrangement in which the metal particles are arranged in a dispersed manner on a whole surface of the magnetic recording layer;
removing the third metal particle arrangement of the second region and exposing the second region on the magnetic recording layer; and
forming, on the magnetic recording layer of the second region, a fourth metal particle arrangement in which the metal particles are arranged in a dispersed manner at higher percentage content than the third metal particle arrangement in the surface direction of the substrate.

16. A magnetic recording device comprising:
a magnetic recording medium used in a heat assist magnetic recording system and including a magnetic recording layer and a metal particle layer above a substrate, the metal particle layer including a first region and a second region positioned at an outer periphery side of the first region,
wherein in the metal particle layer, metal particles are separated to each other and arranged in a dispersed manner, and percentage content of the metal particles in the second region is higher than percentage content of the metal particles in the first region in a surface direction of the substrate;
a near-field light irradiation unit configured to irradiate the magnetic recording medium with near-field light; and
a magnetic field application unit configured to apply a magnetic field to the magnetic recording medium.

17. The magnetic recording device according to claim 16, wherein the metal particle is made of one or more materials selected from a group consisting of gold, silver, aluminum, platinum, and an alloy mainly containing at least one of these types of metals.

18. The magnetic recording device according to claim 16, wherein a heat sink layer made of a material having higher heat conductivity than the magnetic recording layer is provided between the substrate and the magnetic recording layer.

19. The magnetic recording device according to claim 16, wherein a heat barrier layer made of a material having lower heat conductivity than the magnetic recording layer is provided between the substrate and the magnetic recording layer.

20. The magnetic recording device according to claim 17, wherein a heat sink layer made of a material having higher heat conductivity than the magnetic recording layer is provided between the substrate and the magnetic recording layer.

21. The magnetic recording medium according to claim 1, wherein the metal particles that are adjacent to each other are separated by an inter metal particle region made of an insulator.

22. The magnetic recording device according to claim 16, wherein the metal particles that are adjacent to each other are separated by an inter metal particle region made of an insulator.
